(19) United States
(12) Patent Application Publication
(10) Pub. No.: US 2003/0131145 A1
(43) Pub. Date: Jul. 10, 2003

(54) Passing parameters to an external command via the command environment

(75) Inventor: James M. Mcardle, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/042,494

(22) Filed: Jan. 9, 2002

(51) Int. Cl. G06F 9/46; G06F 9/00

(52) U.S. Cl. 709/320

(57) ABSTRACT

The invention provides a method of passing parameters within a customized command environment. The command environment will be stored as an array of strings. At least one parameter will be added as a string variable to the array. The customized command environment will be invoked with the added parameters.

### RELATED APPLICATION

This application relates to U.S. patent application Ser. No. ______ “Creation of a Customized Command Environment”, by James M. McArdle, (IBM Dkt. No. AUS920010928US1) filed concurrently herewith.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### FIELD OF THE INVENTION

The present invention relates generally to a technique for passing parameters within a customized command environment.

### BACKGROUND OF THE INVENTION

Passing parameters from a program application to an external command is fraught with many problems. Parameters may contain imbedded spaces or special characters that may cause the external command to fail to launch. The command processor may strip off any quoting mechanism prior to running the external command breaking parameters with embedded spaces. Some parameters may also be limited to a certain number of characters. For all of these reasons, maintaining the accuracy of the password to be used by an external command can be quite troublesome.

### SUMMARY OF THE INVENTION

One aspect of the present invention is a method of passing parameters within a customized command environment. The command environment will be stored as an array of strings. At least one parameter will be added as a string variable to the array. The customized command environment will be invoked with the added parameters.

Another aspect of the present invention is a computer usable medium storing a program for storing the command environment as an array of strings; adding one or more parameters as a string variable to the array; and invoking the customized command environment with the added parameters.

Another aspect of the present invention is a system for passing parameters within a customized command environment comprising means for storing the command environment as an array of strings; adding at least one parameter as a string variable to the array; and invoking the customized command environment with the added parameters.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a flow chart illustrating one embodiment of a method for passing parameters within a customized command environment in accordance with the present invention;

FIG. 2 is a code sample illustrating one embodiment of a method for invoking a command to create a customized command environment in accordance with the present invention;

FIG. 3 is a code sample illustrating one embodiment of a method for capturing the default system environment in accordance with the present invention; and

FIG. 4 is a block diagram illustrating one embodiment of a system for passing parameters within a customized command environment in accordance with the present invention.

### DETAILED DESCRIPTION OF THE PRESENTLY PREFERRED EMBODIMENTS

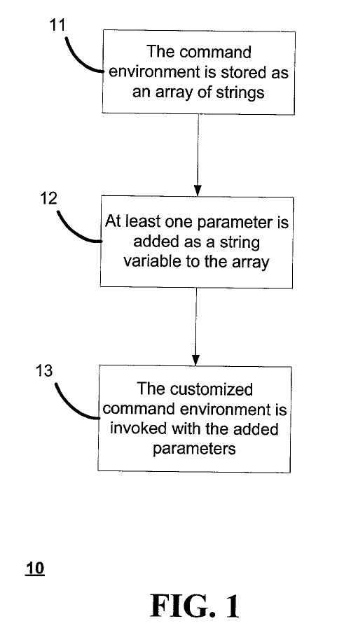

Referring to FIG. 1, one embodiment of a method for passing parameters within a customized command environment is generally shown at numeral 10. This example shows a method of passing parameters within a customized command environment from a programming application. The command environment may be stored in an array of strings, (Block 11). The array of strings is a data type that may be used to organize the information in memory. At least one parameter may be added as a string variable to the array of strings, (Block 12). The customized command environment may be invoked with the added parameters, (Block 13).

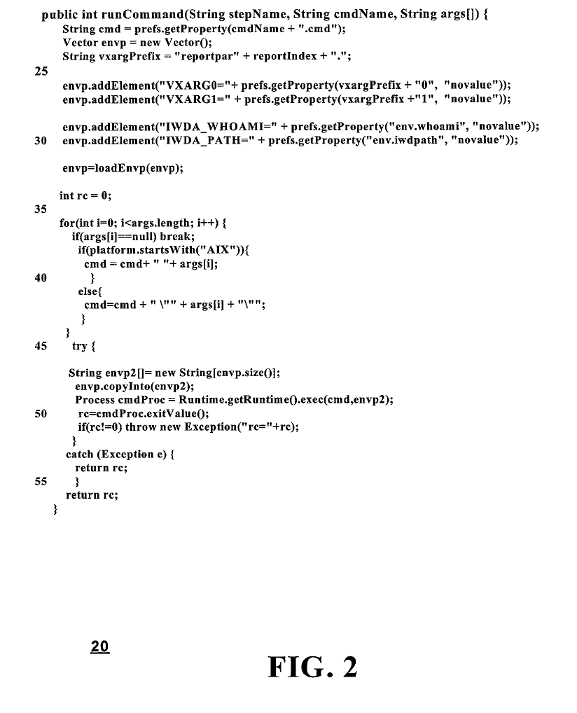

Referring to FIG. 2, one embodiment of a method for invoking a command to create a customized command environment is generally shown at numeral 20. Using programming languages known in the art, one implementation of passing parameters within a customized command environment may be used for running IBM's WebSphere Commerce Analyzer Configuration program, which launches vendor provided command scripts

At Block 25 vendor parameters are added into the array of strings that is used to store the customized command environment. At Block 30 the code adds specific product parameters into the array of strings that is storing the customized command environment. Block 30 then invokes the loadEnvp command to create the customized command environment with the added parameters. Blocks 35 and 40 get the command ready to execute. Block 50 runs the command with the customized command environment, including the added parameters.

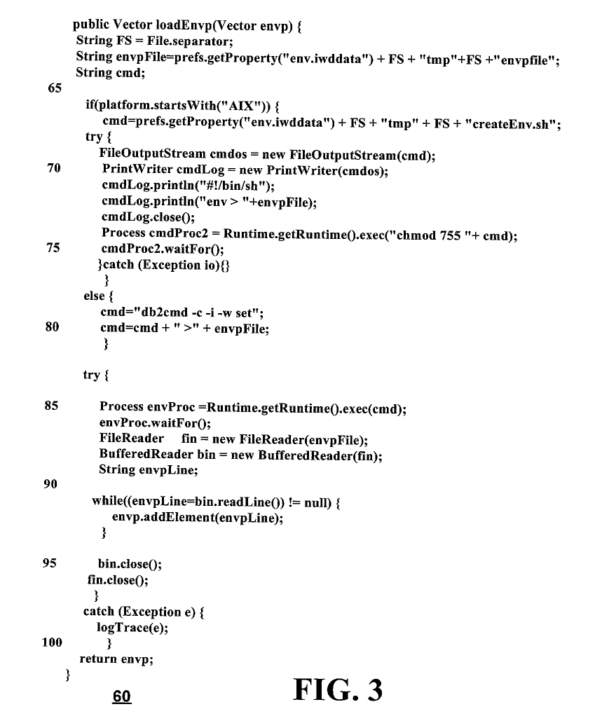

Referring to FIG. 3, one embodiment of a method for capturing the default system environment is generally shown at numeral 60. Using programming languages known in the art, one implementation of the creation of a command environment may be used for running IBM's WebSphere Commerce Analyzer Configuration program, which launches vendor provided command scripts.

At Block 65 the operating system running on the current server is determined. Separate code will be executed depending on which operating system is being used. At Blocks 65 and 70, AIX specific code is used to capture the system command environment. If AIX is not the current operating system, Blocks 75 and 80 will be executed to capture the system command environment for Windows operating systems. Finally, at Blocks 85 and 90 the environment will be read back from memory and stored in an array of strings.

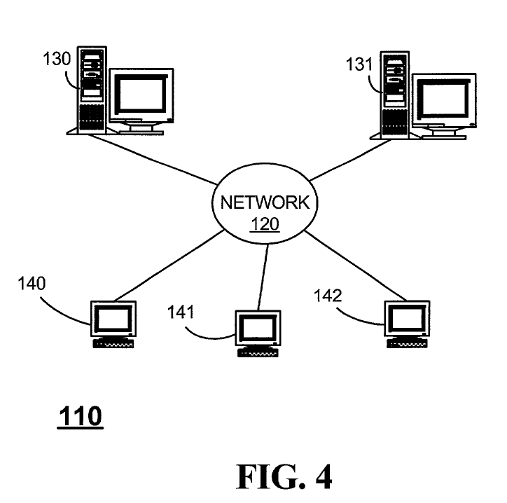

Referring to FIG. 4, one embodiment of a system for passing parameters within a customized command environment is generally shown at numeral 110. In this example, the shown system may be a general network comprising clients and servers. This network, 120, may provide communication links between various devices and computers connected together within this environment. Network 120 may include permanent connections, such as wire or fiber optic cables, or temporary connections made through telephone or wireless communications.

In the example shown, one or more servers, depicted at 130 and 131, may be used for running network software applications. Clients 140, 141, and 142 may also exist within the environment and may represent individual users on the system.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method of passing parameters within a customized command environment comprising:
storing the command environment as an array of strings;
adding at least one parameter as a string variable to the array; and
invoking the customized command environment with the added parameters.

2. The method of claim 1 further comprising:
creating the customized command from within a programming application.

3. The method of claim 1 further comprising:
creating the parameter within the programming application.

4. The method of claim 1 wherein the parameter is selected from a group consisting of standard characters, special characters, and embedded spaces.

5. A computer usable medium storing a program for passing parameters within a customized command environment comprising:
computer readable code to store the command environment as an array of strings;
computer readable code to add one or more parameters as a string variable to the array; and
computer readable code to invoke the customized command environment with the added parameters.

6. The computer usable medium of claim 5 further comprising:
computer readable code for creating the customized command from within a programming application.

7. The computer usable medium of claim 5 further comprising:
computer readable code for creating the parameter within the programming application.

8. The computer usable medium of claim 5 wherein the parameter is selected from a group consisting of standard characters, special characters, and embedded spaces.

9. A system for passing parameters within a customized command environment comprising:
means for storing the command environment as an array of s strings;
means for adding at least one parameter as a string variable to the array; and
means for invoking the customized command environment with the added parameters.

10. The system of claim 9 further comprising:
means for creating the customized command from within a programming application.

11. The system of claim 9 further comprising:
means for creating the parameter within the programming application.
